(19) United States
(12) Patent Application Publication
(10) Pub. No.: US 2003/0200323 A1
(43) Pub. Date: Oct. 23, 2003

(54) Coupling apparatus for the coupling of devices to a bus system

(75) Inventors: Franz Josef Dold, Furtwangen (DE); Jens Niehus, Gundelfingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch/Breisgau (DE)

(21) Appl. No.: 10/375,902

(22) Filed: Feb. 26, 2003

(30) Foreign Application Priority Data
Mar. 18, 2002 (DE) 10211939.2

(51) Int. Cl. G06F 15/16

(52) U.S. Cl. 709/230

(57) ABSTRACT

A coupling apparatus is described for the coupling of devices such as sensors, actuators or controls to a bus system. The communication between the devices, i.e. the transmission and/or reception of data via the bus system takes place via any desired given first communications protocol (bus protocol). At least one interface at the device side is provided for the connection of a device to the coupling apparatus, with the interface at the device side being designed for the communication with the device via a second standardized communications protocol different from the bus protocol. Furthermore, at least one interface at the bus side is provided for the connection of the coupling apparatus to the bus system, with the interface at the bus side being designed for communication with the bus system via the bus protocol. The coupling apparatus includes a protocol conversion unit by which data received via the interface at the bus side can be converted into the standardized communications protocol and data received via the interface at the device side can be converted into the bus protocol.

The present invention relates to a coupling apparatus for the coupling of devices such as sensors, actuators, or controls to a bus system. Furthermore, the invention is directed to an electronic monitoring system comprising at least one device which is connected to a bus system for the transmission and/or reception of data.

In many applications, different devices today communicate with one another via a bus system, with a plurality of different bus systems based on different communications protocols being known. The spread of so-called security buses, which are based on standard field bus protocols, is also increasing in the field of electronic monitoring. To make communication possible for a plurality of different bus protocols, it is necessary for the device manufacturers to integrate corresponding security buses into the devices.

Due to the plurality of known security bus systems, every device, which can be a sensor, an actuator or a control, for example, must be equipped with different bus interfaces for an exhaustive supply. The more bus systems that exist and have to be covered, the higher the development and manufacturing costs of corresponding devices. This is no longer economic in a number of cases so that a reduction in the costs in the development and manufacture of the devices is desired.

Since the bus systems are not prescribed by the device manufacturers, but by the customers in dependence on the application, it must be ensured that the devices can work together with a plurality of different bus systems.

It is also disadvantageous in the plurality of different security bus systems that a separate operating software with corresponding communications and data access protocols has to be developed in each case for a configuration and diagnosis of the devices which usually takes place via the bus system; this requires an additional effort.

It is the object of the invention to provide a cost favorable solution with which different devices such as sensors, actuators and controls can be connected to the most varied bus systems with different bus protocols, with in particular a coupling and communication being possible in a simple manner via different security bus systems. Finally, the effort for the configuration and diagnosis of the individual devices should be reduced.

This object is satisfied in accordance with the invention by a coupling apparatus of the kind first mentioned in which the communication between the devices, i.e. the transmission and/or reception of data via the bus system, takes place via any desired given first communications protocol (bus protocol), with this coupling apparatus including the following elements: at least one interface at the device side for the connection of a device to the coupling apparatus, with the interface at the device side being designed for communication with the device via a second standardized communications protocol different from the bus protocol; at least one interface at the bus side for the connection of the coupling apparatus to the bus system, with the bus interface at the bus side being designed for communication with the bus system via the bus protocol; and at least one protocol conversion unit by which data received via the interface at the bus side can be converted into the standardized communications protocol and data received via the interface at the device side can be converted into the bus protocol.

A standardized interface is thus provided by the invention by which it is ensured that a plurality of different devices, which can all exchange data via a uniform, standardized communications protocol, can work together with a plurality of different bus systems and with bus protocols associated therewith. It is thus no longer necessary to make all devices so complex that they can work together with every different bus protocol. In this manner, the development and manufacturing effort of the devices can be significantly minimized.

The coupling apparatus converts the data transmitted by the devices by means of the standard protocol into the respectively used bus protocol such that the standardized devices can be used with any desired bus systems.

It is also ensured by the standardized device interface that the configuration and diagnosis of the devices can be carried out via a uniform communications protocol and data access protocol.

The standardized communications protocol is selected such that it can be easily superimposed over all known bus protocols as well as also over a serial interface, with preferably block-oriented data transmission protocols being suitable. It is advantageous in this case for corresponding data keeping in accordance with block structure also to be integrated in the devices. It is, however, generally also possible to use object-oriented protocols which realize the data keeping by means of objects in the devices.

In order to observe the regulations required for the security technology in the case of secure communication via a security bus system, the standardized communications protocol is fitted with corresponding security mechanisms (security layers) in order to thus obtain approval in accordance with relevant security standards. The invention can generally be used both with secure and insecure bus systems. If basic details of the invention are described in this application by way of example only with reference to secure/insecure communications, these details are also applicable with insecure/secure communications.

In accordance with an advantageous embodiment of the invention, CAN, Profibus, Interbus, Ethernet, ASI, DeviceNet or CANopen is used as the bus protocol. The bus protocol is in particular designed as a secure communications protocol when used in security technology. In this case, the devices are also made as security devices, with both secure and insecure devices, for example, as already mentioned, being able to be connected to a coupling apparatus made in accordance with the invention.

In accordance with a further preferred embodiment of the invention, at least one control unit is provided for the configuration and/or diagnosis of the devices, with the control unit advantageously being connected to the devices via the bus system such that both the configuration and the diagnosis of the devices takes place by data transmission via the bus system. It is, however, generally also possible for the control unit to be connectable directly to the coupling apparatus or to the devices themselves for the configuration and/or diagnosis.

In accordance with a further advantageous embodiment of the invention, the control unit can be provided inside the coupling apparatus and can be addressed via the bus system, with the control unit usually being made as a software module inside the coupling apparatus, whereby the installation of separate operating software on a separate customer PC becomes superfluous. In particular when the control unit can be addressed via standardized communications protocols and/or can communicate with the devices via standardized communication protocols, it is possible to carry out the configuration and/or the diagnosis of the devices via a standard communications program which can communicate with the control unit provided inside the coupling apparatus via a standard communications program. In accordance with an advantageous embodiment of the invention, for example, the control unit can thus include a web server and can be addressable by a standardized web browser via the bus system. The configuration and/or diagnosis of the devices can in this case thus take place from a standard PC which is connected to the bus system.

It is generally also possible for the control unit to be made as a separate unit which can be connected to the bus system. It is also possible here for the control unit to be made either as a software module, which is installed, for example, on a standard PC connected to the bus system, or for the control unit to be made as a stand alone control apparatus with corresponding software. The control unit can here also be addressable via standardized communications protocols and/or can communicate with the devices via standardized communications protocols. In this case, the control unit can, for example, thus also include a web server which, in contrast to the previous embodiment, does not run inside the coupling apparatus, but, for example, on a customer PC and is addressable via a standardized web browser likewise installed on the customer PC. In this case, the corresponding configuration data and/or diagnosis data are forwarded via the bus system to the coupling apparatus and subsequently from there to the respective device, while—in the aforesaid embodiment—only the control data for the control unit are transmitted via the bus system, while the actual configuration and/or diagnosis data, however, are forwarded directly from the control unit provided inside the coupling device to the respective device.

In accordance with a further advantageous embodiment of the invention, the bus protocol of the respectively connected bus system can be recognized by the coupling apparatus and the protocol conversion unit can be automatically set in accordance with the respectively recognized bus protocol. It is ensured in this manner that, after the connection of the coupling apparatus to the bus system and a corresponding connection of the device/devices to the coupling apparatus, the whole system can be used directly automatically. Generally, however, it is also possible for the protocol conversion unit to be manually adjustable to the bus protocol of the respectively connected bus system. This is in particular sensible when an automatic recognition is not possible due to the bus protocol used.

In accordance with a further preferred embodiment of the invention, a device connected to the coupling apparatus can be clearly identifiable by the coupling apparatus, with an identification of the device by the coupling apparatus taking place, for example, on each configuration access and/or on each operational start of the device and/or of the coupling apparatus. Changes of the installation configuration, which can be forwarded to a corresponding central control, are, for example, recognized by such a monitoring of the devices by the coupling apparatus.

Furthermore, in accordance with a preferred embodiment of the invention, it is also possible for an integrated data processing unit to be provided with which the data supplied from a device or from the bus system can be processed according to pre-determined rules. In this manner, for example, logical links and a pre-processing of the data are possible.

In accordance with a further embodiment of the invention, just one interface is present at the device side for the connection of a device. However, a coupling apparatus in accordance with the invention can advantageously have a plurality of interfaces at the device side for the connection of a plurality of devices. In this manner, different devices can be connected to the bus system by means of a single coupling apparatus. It is furthermore possible for the coupling apparatus also to be able to forward local field signals (inputs and outputs) to the lower layer (security) devices and, vice versa, also to be able to output these locally. It is likewise possible for both secure and insecure data signals to be able to be read in and/or output via the interface at the device side and/or via the interface at the bus side.

The communications can also take place via the standardized secure communications protocol with the security devices when the described web server is used. The operating software integrated in the web server can then be activated and operated via the said web browser.

It is ensured by the invention that the same data access always applies irrespective of the bus system used for the individual devices. It is ensured by the use of a standardized (secure) communications protocol and of a (secure) data access protocol, which are superimposed on the different field bus protocols, that the identical communications language always exists between the operating software and the individual devices. The standardized communications protocols are also used for the communications protocols, with the standardized communications protocol in accordance with the invention likewise being used for configuration backup and download by means of certified software modules.

The invention can be used for any kind of devices such as sensors, actuators and controls, of a secure and insecure kind, which have a common communications interface. These devices can thus also be designated as standard devices or standardized security devices.

The development costs for the devices are reduced by the invention since all standardized (security) devices are connectable to the respective (security) bus system by means of a coupling device. Furthermore, a transparent configuration/diagnosis data access is possible via any desired underlying communications protocols.

A further advantage of the invention lies in the fact that a single piece of operating software can communicate with the (security) devices via any desired security protocols as well as standard protocols. Only the exchange of the communications drivers is necessary.

Software modules can also be used again in further developments by the use of identical interfaces. The coupling apparatus is also advantageous from the user aspect, since the connected device behaves in accordance with the demanded device specifications of the respective bus system and since furthermore the user can use the already familiar operating tools of the device manufacturer.

Further advantageous embodiments of the invention are recited in the dependent claims.

The invention will be explained in more detail in the following with reference to embodiments and to the drawing, in which are shown:

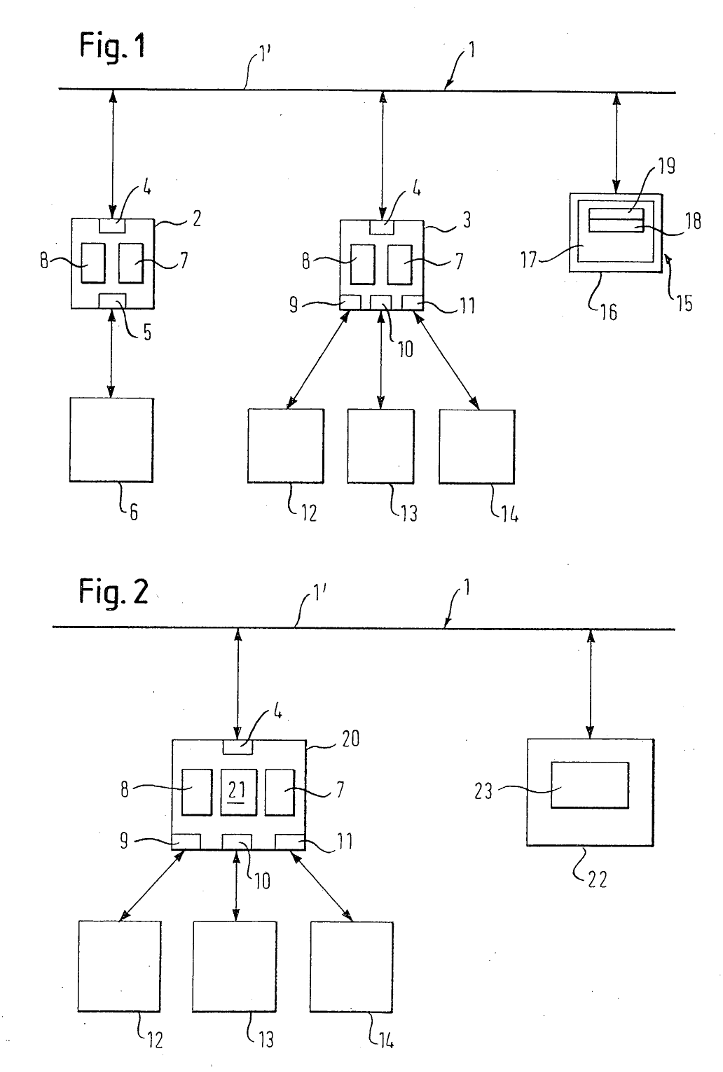

FIG. 1 a block diagram of two different embodiments of a coupling apparatus in accordance with the invention for the connection of devices to a bus system; and

FIG. 2 a block diagram of a further embodiment of coupling apparatus formed in accordance with the invention.

FIG. 1 shows the databus 1′ of a bus system 1 to which two coupling apparatuses 2, 3 made in accordance with the invention are connected. The coupling apparatus 2 has an interface 4 at the bus side for the connection of the coupling apparatus 2 to the bus system 1 as well as an interface 5 at the device side for the connection of a device 6 to the coupling apparatus 2. The device 6 can, for example, be a sensor, an actuator or a control.

The coupling apparatus 2 furthermore includes a protocol conversion unit 7 as well as an integrated data processing unit 8.

The data signals generated by the device 6, for example by a sensor, are transmitted to the interface 5 at the device side via a standardized communications protocol and are subsequently converted inside the coupling apparatus 2 by the protocol conversion unit 7 into the bus protocol used on the bus system 1. A data pre-processing of the data delivered by the device 6 can take place prior to, during or after the conversion.

The last converted data are forwarded by the interface 4 at the bus side to the bus system 1 and forwarded via the latter to the receiver of the data.

It is possible by the standardization of the communications protocol between the interface 5 at the device side and the device 6 to replace the device 6 by any desired other standardized devices without impairing the communications via the bus system 1. It is likewise possible to use the device 6 with another bus system which is operated with another bus protocol.

The coupling apparatus 3 likewise shown in FIG. 1 differs from the coupling device 2 only in that three interfaces 9, 10, 11 at the device side are provided instead of one interface 5 at the device side. Each of these interfaces 9, 10, 11 at the device side is connected to a device 12, 13, 14 which are each in communication with the coupling apparatus 3 via the standardized communications protocol.

In this embodiment of the coupling apparatus 3, it is thus possible to connect a plurality of devices to the bus system 1 via a single coupling apparatus 3. Here, too, both any desired replacement of the standardized devices 12, 13, 14 by other standardized devices and an exchange of the bus system 1 by a bus system with another bus protocol is possible.

FIG. 1 furthermore shows a control unit 15 which can consist, for example, of a personal computer 16 as well as operating software 17 installed on it. The user can, for example, query the status of the individual devices 6, 12, 13, 14 for diagnosis or configure the devices via the operating software 17. The corresponding data signals are generated via an interface 18 in the standardized communications protocol and are subsequently converted via a conversion unit 19 into the respective bus protocol used on the bus system 1 or superimposed on it. It is ensured in this way that the control unit 15 can also be used with the associated bus protocol irrespective of the respectively used bus system 1.

In the embodiment in accordance with FIG. 2 elements already described in FIG. 1 are provided with the same reference numerals as in FIG. 1.

FIG. 12 shows a coupling apparatus 20 in accordance with the invention in which a control unit 21 is additionally integrated in addition to the interfaces 4, 9, 10, 11 and to the protocol conversion unit 7 as well as to the optional data processing unit 8. The control unit 21 can, for example, include a web server which can communicate with the devices 12, 13, 14 via the interfaces 9, 10, 11 and via the standardized communications protocol. In particular, configuration data can thus be transmitted from the control unit 21 to the devices 12, 13, 14 and diagnosis data can be read out of these.

The operation of the control unit 21 takes place via a standard PC 22 which is connected to the bus system 1 and on which, for example, a standardized web browser 23 is installed. Operating software which is integrated inside the web server of the control unit 21 can, for example, be activated via the web browser 23 and can be operated to control the devices 12, 13, 14.

In this embodiment, neither a specialized control unit 21 nor the installation of special software on a personal computer serving as the control unit is thus required for the configuration and diagnosis of the devices 12, 13, 14, since only a standard PC is connected to the bus system 1 for the operation of the integrated control unit.

### Reference Numeral List

1 bus system

1′ databus

2 coupling apparatus

3 coupling apparatus

4 interface at the bus side

5 interface at the device side

6 device

7 protocol conversion unit

8 data processing unit

9 interface at the device side

10 interface at the device side

11 interface at the device side

12 device

13 device

14 device

15 control unit

16 personal computer

17 operating software

18 interface

19 conversion unit

20 coupling apparatus

21 control unit

22 standard PC

23 web browser

1. A coupling apparatus for the coupling of devices (6, 12, 13, 14) such as sensors, actuators or controls to a bus system (1), wherein the communication between the devices (6, 12, 13, 14), i.e. the transmission and/or reception of data via the bus system (1), takes place via any desired given first communications protocol (bus protocol), there being
at least one interface (5, 9, 10, 11) at the device side for the connection of a device (6, 12, 13, 14) to the coupling apparatus (2, 3, 20), with the interface (5, 9, 10, 11) at the device side being designed for communication with the device (6, 12, 13, 14) via a second standardized communications protocol different from the bus protocol;
an interface (4) at the bus side for the connection of the coupling apparatus (2, 3, 20) to the bus system (1), wherein the interface (4) is made for the communication with the bus system (1) via the bus protocol;
and at least one protocol conversion unit (7) by which
data received via the interface (4) at the bus side can be converted into the standardized communications protocol,
and data received via the interface (5, 9, 10, 11) at the device side can be converted into the bus protocol.

2. A coupling apparatus in accordance with claim 1, characterized in that CAN, Profibus, Interbus, Ethernet, ASI, DeviceNet or CANopen is used as the bus protocol.

3. A coupling apparatus in accordance with claim 1, characterized in that the bus protocol is a secure communications protocol.

4. A coupling apparatus in accordance with claim 1, characterized in that the devices (6, 12, 13, 14) are formed as security devices.

5. A coupling apparatus in accordance with claim 1, characterized in that at least one control unit (15, 21) is provided for the configuration and/or diagnosis of the devices (6, 12, 13, 14).

6. A coupling apparatus in accordance with claim 5, characterized in that the control unit (21) is provided inside the coupling apparatus (20) and can be addressed via the bus system (1).

7. A coupling apparatus in accordance with claim 5, characterized in that the control unit (15) is made as a separate unit which can be connected to the bus system (1).

8. A coupling apparatus in accordance with claim 5, characterized in that the control unit (15, 21) can be addressed via standardized communications protocols and/or can communicate with the devices (2, 12, 13, 14) via standardized communications protocols.

9. A coupling apparatus in accordance with claim 5, characterized in that the control unit (15, 21) includes a web server and can be addressed by a standardized web browser (23) via the bus system (1).

10. A coupling apparatus in accordance with claim 5, characterized in that the control unit (21) is made as a software module.

11. A coupling apparatus in accordance with claim 1, characterized in that the bus protocol of the respectively connected bus system (1) can be recognized by the coupling apparatus (2, 3, 20) and the protocol conversion unit (7) can be set automatically in accordance with the respectively recognized bus protocol.

12. A coupling apparatus in accordance with claim 1, characterized in that the protocol conversion unit (7) can be set manually to the bus protocol of the respectively recognized bus system (1).

13. A coupling apparatus in accordance with claim 1, characterized in that a device (6, 12, 13, 14) connected to the coupling apparatus (2, 3, 20) can be identified by the coupling apparatus (2, 3, 20).

14. A coupling apparatus in accordance with claim 13, characterized in that an identification of the device (6, 12, 13, 14) takes place by the coupling apparatus (2, 3, 20) on each configuration access and/or on each operational start of the device (6, 12, 13, 14) and/or of the coupling apparatus (2, 3, 20).

15. A coupling apparatus in accordance with claim 1, characterized in that an integrated data processing unit (8) is provided with which the items of data delivered from a device (6, 12, 13, 14) or from the bus system (1) can be processed in accordance with pre-determined rules and can in particular be logically linked to one another.

16. A coupling apparatus in accordance with claim 1, characterized in that just one interface (5) at the device side is present for the connection of a device (6).

17. A coupling apparatus in accordance with claim 1, characterized in that a plurality of interfaces (9, 10, 11) are present for the connection of a plurality of devices (12, 13, 14).

18. A coupling apparatus in accordance with claim 1, characterized in that both secure and non secure data signals can be read in and/or output via the interface (5, 9, 10, 11) at the device side and/or via the interface (4) at the bus side.

19. An electronic monitoring system comprising at least one device (6, 12, 13, 14) which is connected to a bus system (1) for the transmission and/or reception of data, characterized in that the device (6, 12, 13, 14) is connected to the bus system (1) via a coupling apparatus (2, 3, 20) in accordance with claim 1.
